(19) United States
(12) Patent Application Publication
(10) Pub. No.: US 2006/0036698 A1
(43) Pub. Date: Feb. 16, 2006

(54) Method and system to discourage a sender from communicating an electronic message to a user

(76) Inventors: Cedric R.J. Hebert, Mouans-Sartoux (FR); Cedric S.P. Ulmer, Nice (FR); Laurent Y. Gomez, Le Cannet (FR); Pascal T.C. Spadone, Antibes (FR); Maarten F. Rits, Sophia Antipolis (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/933,904

(22) Filed: Sep. 2, 2004

Related U.S. Application Data
(63) Continuation of application No. PCT/FR04/01839, filed on Jul. 13, 2004.

(51) Int. Cl. G06F 15/16

(52) U.S. Cl. 709/206

(57) ABSTRACT

A system to update a filter to discourage a sender from communicating an electronic message to a user. The system receives a message from a sender that includes a network address of the sender and determines whether to discourage the sender from communicating a second message to the user based on input from a user. If a user indicates that the sender should be discouraged, the system updates the filter by registering the network address of the sender in the filter that is subsequently utilized to communicate a response message to the sender that includes an error code indicating that the network address of the user is an invalid network address. A system to use a filter to discourage a sender from communicating the second message to a user and a system to automatically remove a user from a mailing list are also described.

### PRIORITY CLAIM

The present patent application claims the priority benefit of the filing date of PCT Application No. PCT/FR04/01839 filed Jul. 13, 2004, which is incorporated by reference.

### FIELD OF THE INVENTION

An embodiment relates generally to the technical field of communications and, in one exemplary embodiment, to a method and system to discourage a sender from communicating an electronic message to a user.

### BACKGROUND OF THE INVENTION

E-mail has become an indispensable method of communication for many people. Indeed, e-mail provides an efficient and convenient way to communicate, receive and process messages. Unfortunately, the e-mail system has been exploited by a number of users that use electronic mailing lists to multiply and disseminate a plethora of unwanted material (e.g., SPAM). For example, a user may send a single e-mail to a server that, in turn, copies and communicates the e-mail to thousands of users on a mailing list. Coping mechanisms have been developed. Some users utilize application programs that automatically identify e-mail as SPAM. Other users may attempt to contact the sender and request them to stop sending the e-mail. Unfortunately, some senders may interpret such contact as confirmation of a valid network address and continue to communicate e-mail to the user notwithstanding the expressed desire of the user.

### SUMMARY OF THE INVENTION

According to one aspect, there is provided a method to update a filter to discourage a sender from communicating an electronic message to a user. The method includes receiving a first electronic message from a sender, the electronic message including a network address of the sender; determining whether to discourage the sender from communicating a second electronic message to the user; and if so determined, updating the filter by registering the network address of the sender in the filter that is utilized to communicate an electronic response message to the sender, the electronic response message to discourage the sender from communicating the second electronic message to the user.

According to another aspect, there is provided a method to use a filter to discourage a sender from communicating electronic messages to a user. The method includes receiving an electronic message from a sender, the electronic message including a network address of the sender; identifying that the sender is to be discouraged from communicating a second electronic message to the user by using the filter that is updated by registering the network address of the sender to the filter; and communicating an electronic response message to the sender, the electronic response message to discourage the sender from communicating the second electronic message to the user.

According to a further aspect, there is provided a method to automatically remove a user from a mailing list. The method includes, at a server machine, electronically communicating a first electronic message to a plurality of users respectively identified in a mailing list; at the server machine, receiving a second electronic message that is associated with a user that is included in the plurality of users, the second electronic message including an error code; at the server machine, automatically removing the user from the mailing list based on the error code.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system, according to one exemplary embodiment of the present invention;

FIG. 2 is a block diagram illustrating an e-mail and tables utilized by the system, according to an exemplary embodiment of the present invention;

FIG. 3 is a flow chart illustrating a method, according to an exemplary embodiment of the present invention, to update a filter to discourage a sender from communicating an electronic message to a user;

FIG. 4 is a flow chart illustrating a method, according to an exemplary embodiment of the present invention, to use a filter to discourage a sender from communicating an electronic messages to a user;

FIG. 5 is a flow chart illustrating a method, according to an exemplary embodiment of the present invention, to automatically remove a user from a mailing list;

FIG. 6 is a flow chart illustrating a method, according to an exemplary embodiment of the present invention, to receive an e-mail header;

FIGS. 7-9 illustrate user interface screens, according to an exemplary embodiment of the present invention; and

FIG. 10 illustrates a diagrammatic representation of a machine, in the exemplary form of a computer system, within which a set of instructions, for causing the machine to perform any one or more of the methodologies discussed herein, may be executed.

### DETAILED DESCRIPTION

A method and system to discourage a sender from communicating an electronic message to a user are described. In the following description, for purposes of explanation, numerous specific details are set forth in order to provide a thorough understanding of the present invention. It will be evident, however, to one skilled in the art that the present invention may be practiced without these specific details.

In general, embodiments described below feature a system that uses a filter to discourage a sender from communicating an e-mail to a user. A system receives an e-mail that includes a network address of the user (e.g., e-mail recipient) and a network address of a sender (e.g., mailing list application, author of e-mail, etc.). The system reads the network address of the user from the e-mail to identify a filter that includes a list of network addresses of senders. Next, the system reads the network address of the sender from the e-mail and compares it with the network addresses in the filter. If a match is identified, the system generates a response message and communicates the response message to the sender. The response message includes an error code that indicates that the network address of the user is an invalid network address. The error code is intended to discourage the sender from sending additional e-mail to the recipient. In some embodiments a mailing list application may print out, display, or forward error information. In other embodiments, the author may receive the error message directly.

Another aspect of the above invention includes a system to update a filter that is used to discourage a sender from communicating an e-mail to a user. The system presents a user interface screen to a user (e.g., recipient) for reviewing and identifying unwanted e-mail (e.g., SPAM). The recipient identifies unwanted e-mail by checking a box on the user interface screen that corresponds to the unwanted e-mail. In response, the system reads the address of the sender from the unwanted e-mail and registers it in a filter that is associated with the recipient. Henceforth, the system will utilize the filter to discourage the sender from communicating e-mail to the user, as described above.

Another aspect of the above invention includes a system that automatically removes a user from a mailing list. The system communicates a copy of an e-mail to each user on a mailing list. If the system receives a message from a user on the mailing list that includes an error code then the user is automatically removed from the mailing list.

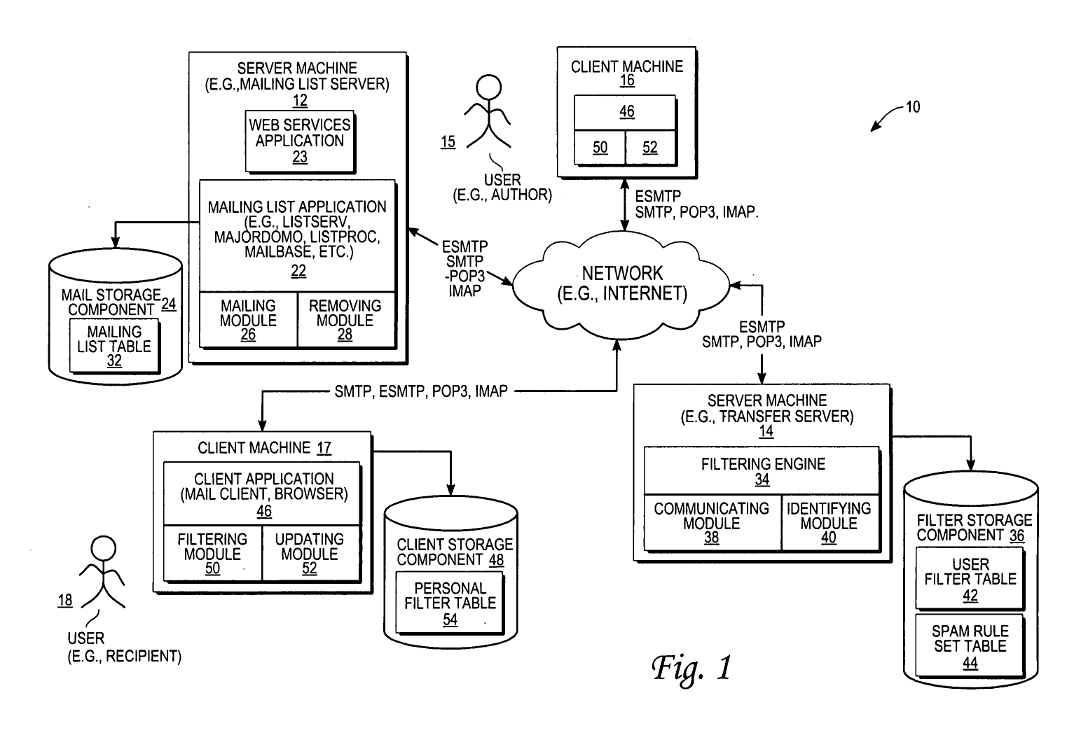

FIG. 1 is a network diagram depicting a system 10, according to one exemplary embodiment, depicting a client-server architecture and a peer-to-peer architecture. The client-server architecture includes a server machine 12, a server machine 14, a client machine 16 and a client machine 17 connected to and communicating over a network 18 (e.g., Internet, LAN, WAN). The client and server machines may utilize a number of different protocols including HTTP, Simple Mail Transfer Protocol (SMTP), Extended Simple Mail Transfer Protocol (ESMTP), Multipurpose Internet Mail Extensions (MIME), X.400; POST OFFICE PROTOCOL (POP), Interactive Mail Access Protocol (IMAP), etc. The peer-peer architecture may include the server machine 12 and the server machine 14.

The server machine 12 includes a mailing list application 22 and a web services application 23 and is connected to a mail storage component 24. The mailing list application 22 (e.g., LISTSERV, MAJORDOMO, LISTPROC, MAILBASE, etc.) includes a mailing module 26 and a removing module 28. The mailing module 22 receives an e-mail from a user and responds by copying and communicating the e-mail to each user that appears on a mailing list. In addition, the mailing module 22 is utilized to administer mailing lists by processing control messages (e.g., add user to mailing list, remove user from mailing list, etc.) and error messages (e.g., invalid network address). The removing module 28 is utilized by the mailing module 22 to remove a user from a mailing list. The mail storage component 24 includes a mailing list table 32 that stores the mailing lists. The web services application 23 provides web interfaces to applications running on the server machine 12 including the mailing list application 22.

The server machine 14 includes a filtering engine 34 and is connected to a filter storage component 36. The filtering engine 34 includes a communicating module 38 and an identifying module 40. The communicating module 38 is utilized to communicate with the server machine 12 and the client machines 16 and 17. The identifying module 40 utilizes a filter to identify an incoming e-mail as unwanted (e.g., SPAM). The filter storage component 36 is utilized to store filters in a user filter table 42 and a spam rule set table 44. The user filter table 42 stores filters that identify the network addresses of e-mail senders that should be discouraged from sending e-mail. The spam rule set table 44 stores rules that the filtering engine 34 applies to an incoming e-mail to identify and mark as incoming e-mail as unwanted.

The client machines 16 and 17 include a client application program 46. In addition, the client machine 17 is connected to a client storage component 48. The client application program 46 is utilized to author, communicate, and receive e-mail over the network 18. The client application program 46, for example, may be a mail client such as the MICROSOFT OUTLOOK mail client developed by Microsoft Corporation of Redmond, Wash. State or an Internet browser such as the INTERNET EXPLORER browser also developed by Microsoft Corporation. The client application program 46 includes a filtering module 50 and an updating module 52. The filtering module 50 is utilized to communicate with server machines 12 and 14 and to add, delete and update filters. The filtering module 50 utilizes the updating module 52 to update a filter by registering a receiver network address in the filter. The client storage component 48 is utilized to store a filter in the form of an exemplary personal filter table 54.

It will be appreciated that other embodiments may include the client application program 46 executing on server machine 14. It will also be appreciated, in yet another embodiment, that the filtering module 50 and the updating module 52 may execute under the filtering engine 34 on the server machine 14.

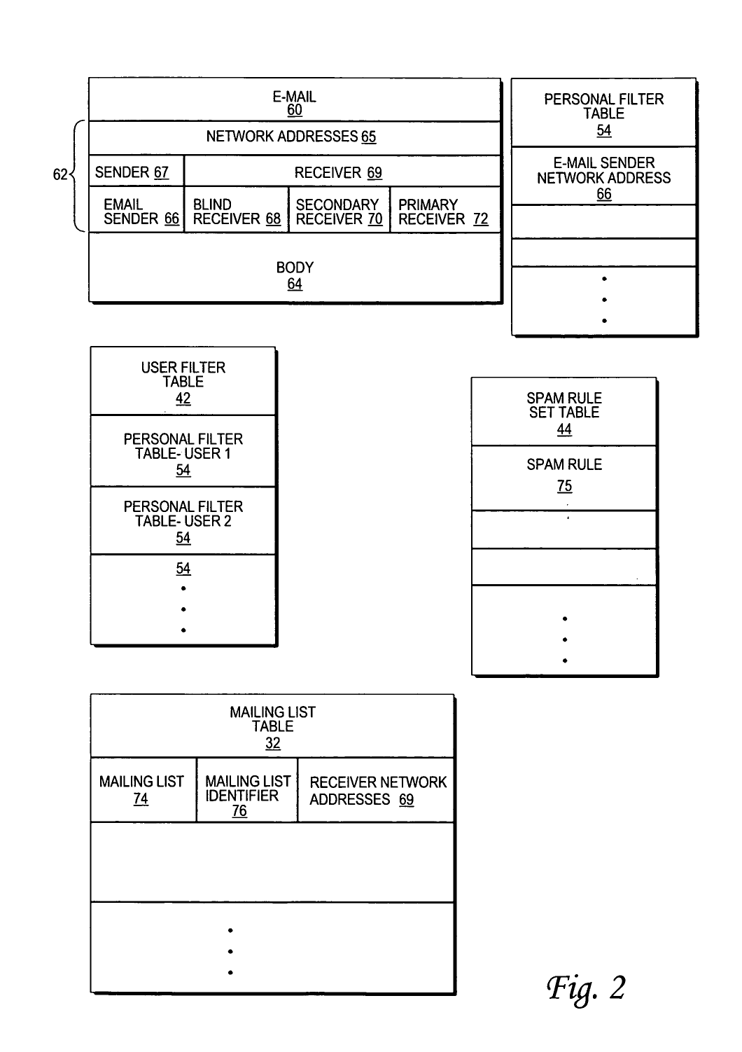

FIG. 2 is a block diagram illustrating an e-mail and various tables, according to an exemplary embodiment, including an exemplary electronic message in the form of an e-mail 60, a personal filter table 54, a user filter table 42, a spam rule set table 44, and a mailing list table 32.

The e-mail 60 includes a header 62 and a body 64. The body 64 may include text and/or an optional file attachment. The header 62 includes network addresses 65 that include sender network addresses 67 and receiver network addresses 69. The sender network addresses 67 include an e-mail sender network address 66. The receiver network addresses 69 include a blind receiver network address 68, a secondary receiver network address 70 and a primary receiver network address 72 (e.g., domain name system (DNS) addresses).

The personal filter table 54 is utilized to store one or more e-mail sender network addresses 66. The personal filter table 54 is updated by the client application program 46 and utilized by the filtering engine 34 to identify and respond to a sender that communicates an e-mail 60 that is unwanted.

The user filter table 42 is stored on the server machine 14 and is utilized by the filtering engine 34 to store multiple personal filter tables 54.

The spam rule set table 44 is utilized to store one or more spam rules 75 that are utilized by the filtering engine 34 to automatically identify and mark incoming e-mail as spam.

The mailing list table 32 stores mailing lists 74. Each mailing list 74 includes a mailing list identifier 76 and one or more receiver network addresses 69.

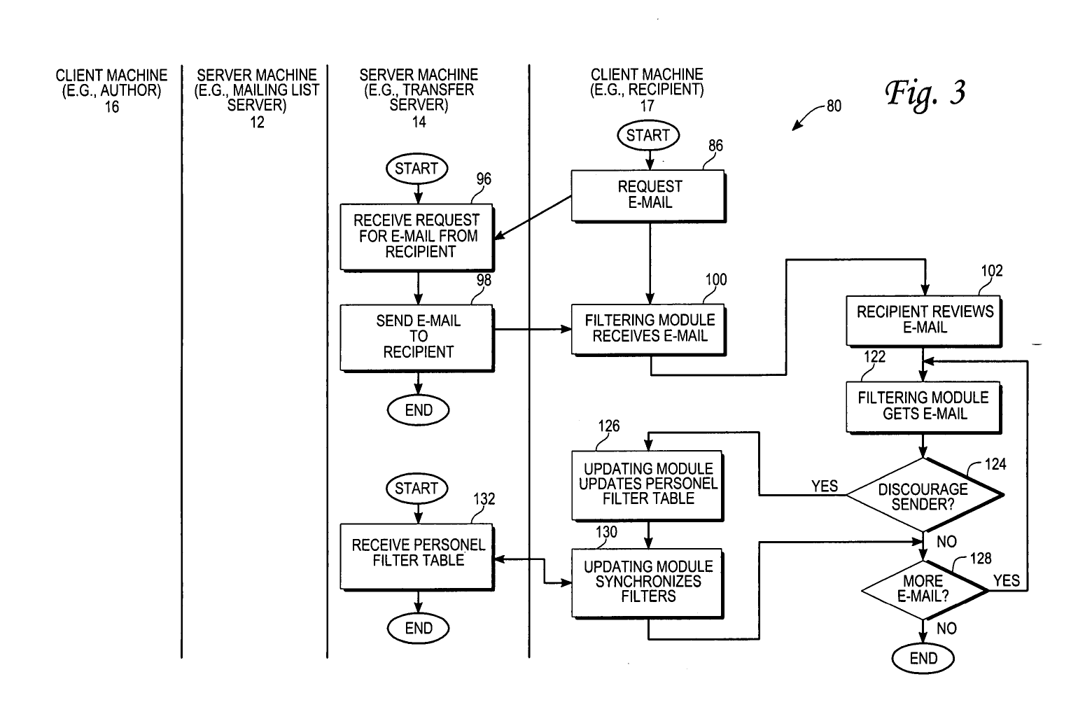

FIG. 3 is a flowchart illustrating a method 80, according to an exemplary embodiment, to update a filter. A server machine 14 (e.g., transfer server) and a client machine 17 (e.g., operated by an e-mail recipient) are illustrated.

At box 94, a user 18 (e.g., recipient) at the client machine 17 utilizes a client application program 46 (e.g., MICROSOFT OUTLOOK) to request e-mail 60 from the server machine 14.

At box 96, the filtering engine 34 at the server machine 14 receives the request for e-mail 60 from the user 18 and communicates, at box 98, the e-mail 60 to the client machine 17.

At box 100, the filtering module 50, on the client machine 17, receives and stores the e-mail 60 including a first electronic message in the form of an exemplary e-mail 60 on the client storage component 48.

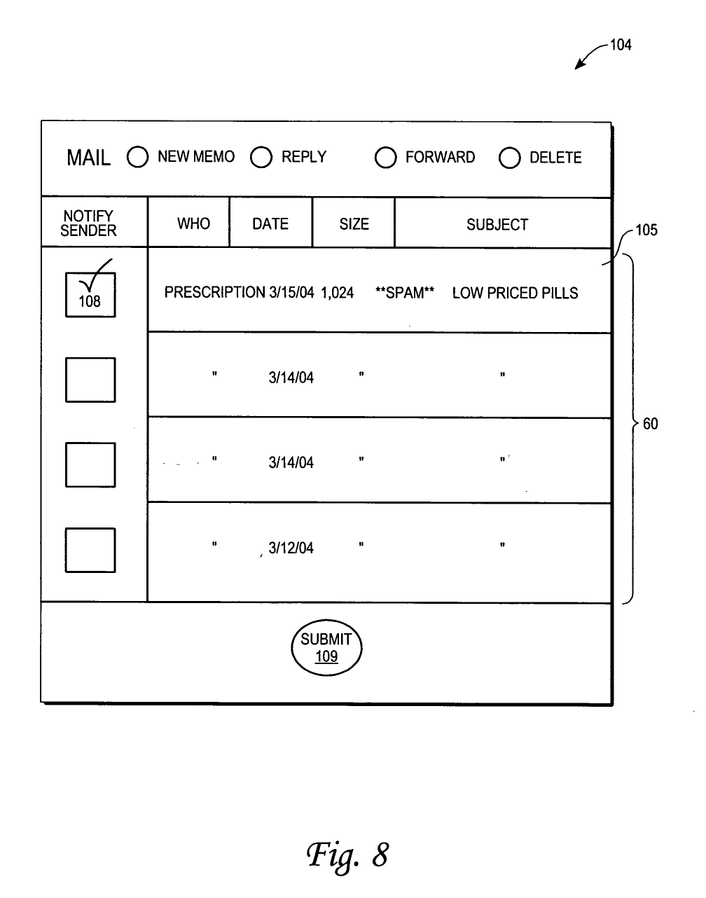

At box 102, the user 18 reviews the e-mail 60 by utilizing a user interface 104 as illustrated on FIG. 8, according to an exemplary embodiment.

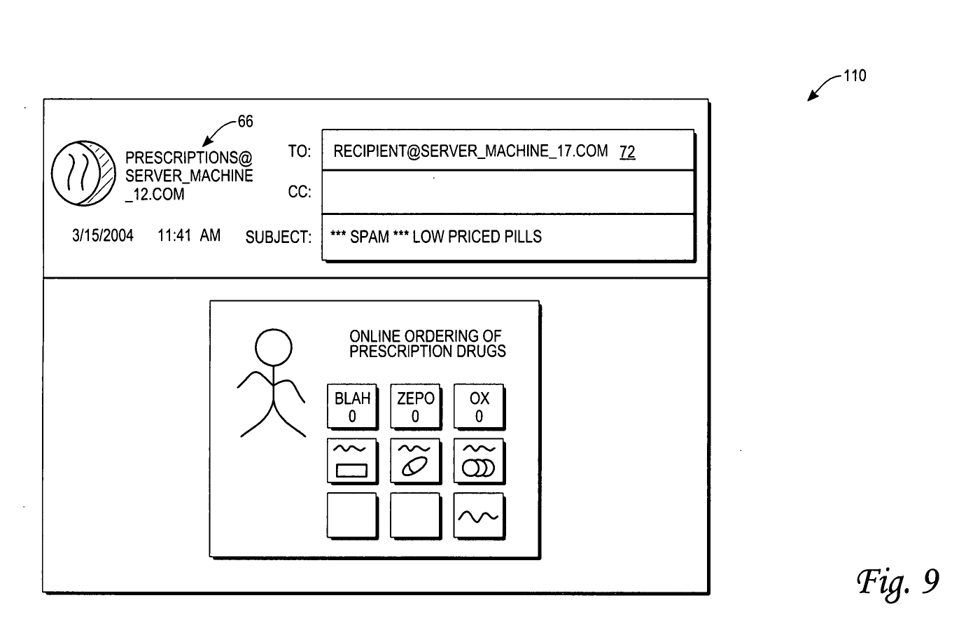

On FIG. 8, the user interface 104 illustrates a summary line 105 and a notify sender checkbox 108 for each e-mail 60 retrieved by the client application program 46. The user 18 reviews the e-mail 60 by selecting the first summary line 105 (e.g., received from “Prescriptions” for “Low Priced Pills”) on the user interface 104. The filtering module 50 responds by displaying a full view of the selected e-mail 60, as illustrated in user interface 110 on FIG. 9, according to an exemplary embodiment.

On FIG. 9, the user interface 110 illustrates the full view of the e-mail 60 including an e-mail sender network address 66 and a primary receiver network address 72. Note that the filtering engine 34 at the sever machine 14 has utilized the spam rule set table to identify the e-mail 60 with the string “** SPAM **”. Nevertheless, the user 18 further wants to discourage the sender at the sender network address 66 (e.g., PRESCRIPTION@SERVER_MACHINE_{—}12.com) from sending additional e-mail and consequently, returning to user interface 104, as illustrated on FIG. 8, the user 18 selects the corresponding notify sender checkbox 108. Finally, the user 18 selects a submit user interface element 109.

At box 122, the filtering module 50 enters a loop to update the personal filter table 54 and gets the next e-mail 60.

At decision box 124, the filtering module 50 determines if the notify sender check box 108 is set for the e-mail 60. If the notify sender check box 108 is set, then the user has manually identified that the sender of the e-mail 60 should be discouraged from sending additional e-mail 60 and a branch is made to box 126. Otherwise, a branch is made to decision box 128.

At box 126, the updating module 52 registers the e-mail sender network address 66 (e.g., PRESRIPTION@SERVER_MACHINE_{—}12.com) in the personal filter table 54.

At box 130, the filtering module 50 synchronizes the personal filter table 54 at the client machine 14 with the corresponding personal filter table that is stored in the user filter table 42 at the server machine 14 by communicating the personal filter table 54 to the server machine 14.

At decision box 128, the filtering module 50 determines if there is more e-mail 60 to process. If there is more e-mail 60 to process, a branch is made to box 122. Otherwise, processing ends on the client machine 17.

At box 132, the filtering module 50, in the filtering engine 34, on the server machine 14, receives and registers the personal filter table 54 in the appropriate entry in the user filter table 42 and processing ends.

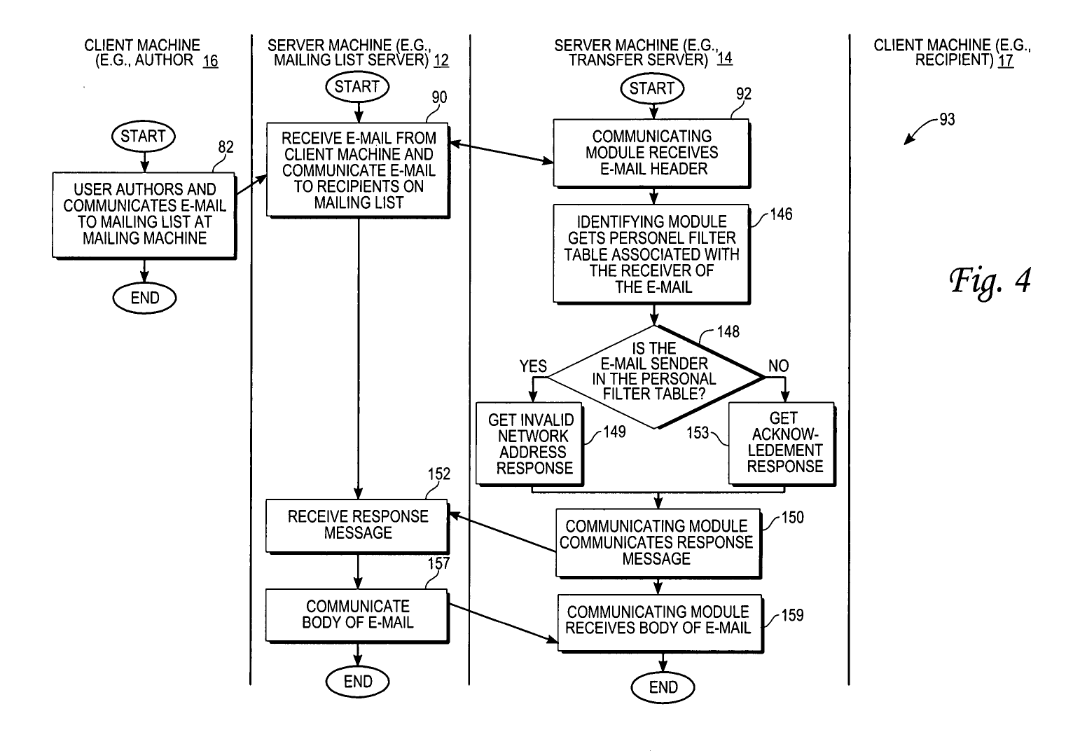

FIG. 4 is a flowchart illustrating a method 93, according to an exemplary embodiment, to use a filter. A client machine 16 (e.g., operated by an e-mail author), a server machine 12 (e.g., mailing list server), a server machine 14 (e.g., transfer server) and a client machine 17 (e.g., operated by a recipient) are illustrated.

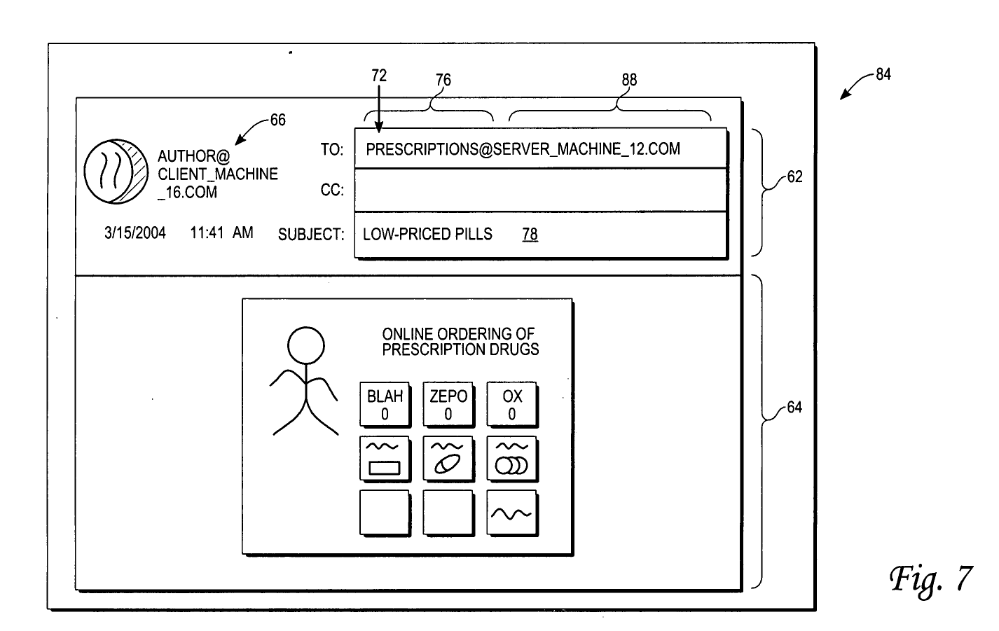

At box 82, a user 15 (e.g., e-mail author) at client machine 16 utilizes a client application program 46 (e.g., MICROSOFT OUTLOOK) to author an e-mail 60 that is addressed to a mailing list 74 that is stored at server machine 12 as illustrated in user interface 84 on FIG. 7.

On FIG. 7, according to an exemplary embodiment, the user interface 84 illustrates the e-mail 60 that includes a header 62 and body 64. The header 62 includes a primary receiver network address 72 and a subject line 78. The primary receiver network address 72 includes a mailing list identifier 76, “PRESCRIPTIONS”, and a domain name system address 88, “@SERVER_MACHINE_{—}12.com”, for the server machine 12. The body 64 includes an advertisement for an online ordering of prescription drugs

Returning to FIG. 4, at box 90, the mailing list application 22 receives the e-mail 60 from the client machine 16. The mailing list application 22 extracts the mailing list identifier 76 from the header 62 of the e-mail 60 and utilizes the mailing list identifier 76 to find the corresponding set of receiver network addresses 69 in the mailing list table 32. Next, the mailing module 26 copies and communicates the e-mail 60 to each of the receiver network addresses 69 in the mailing list table 32.

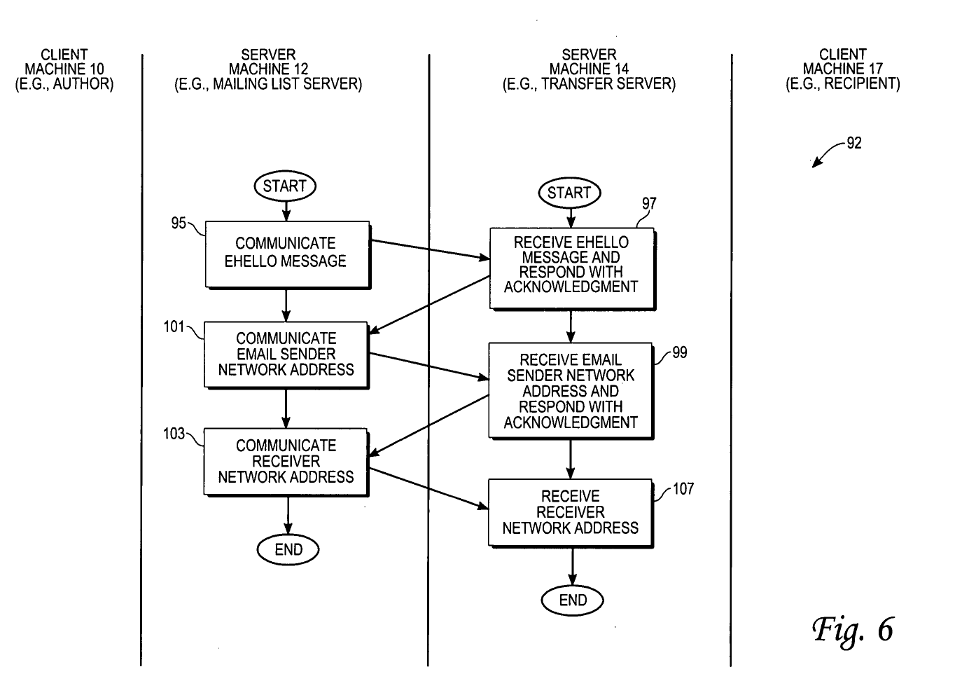

At box 92, the communicating module 38 in the filtering engine 34 at the server machine 14 receives an e-mail header 62 from the server machine 12. FIG. 6 illustrates the box 92, according to an exemplary embodiment. The server machine 12 (e.g., mailing list server) is illustrated on the left and the server machine 14 (e.g., transfer machine) is illustrated on the right.

On FIG. 6, at box 95, the server machine 12, operating as a client, establishes a TCP connection to port 25 of the server machine 14 and communicates an EHELLO message (e.g., Extended simple Mail transfer Protocol as defined by RFC 142) to the server machine 14. It will be appreciate that other protocols may be utilized in other embodiments.

At box 97, the communicating module 38 at the server machine 14 receives the EHELLO message and indicates it is ready to accept an e-mail header by communicating an acknowledgement to the server machine 12.

At box 101, the server machine 12, receives the acknowledgment and communicates a sender network address 66 to the server machine 14.

At box 99, the communicating module 38 at the server machine 14 receives the sender network address 66 and communicates an acknowledgment to the server machine 12.

At box 103, the server machine 12, receives the acknowledgment and communicates a receiver network address 69 to the server machine 14.

At box 107, the communicating module 38 at server machine 14 receives the receiver network address 66 and processing ends.

Returning to FIG. 4, at box 146, the identifying module 40 is passed the receiver network address 69 (e.g., a primary receiver network address 72, a secondary receiver network address 70, a blind receiver network address 68, etc.) from the communicating module 38. Next, the identifying module 40 utilizes the receiver network address 60 to get the corresponding filter in the form of an exemplary personal filter table 54 from the user filter table 42.

In other embodiments, the identifying module may request the personal filter table 54 from the client application program 46. For example, the filtering engine 34 and the client application program may be able to communicate as peers, thus the filtering engine 34 may initiate communication. In yet another embodiment, the client application program 46 may execute on the server machine 14.

At decision box 148, the identifying module 40 searches the personal filter table 54 to identify a sender network address 66 that matches the sender network address 66 in the e-mail 60. If the identifying module 40 identifies a match, a branch is made to box 149. Otherwise, a branch is made to box 153.

At box 149, the communicating module 38 stores an invalid network address error code in an electronic response message. Other embodiments may utilize other error codes.

At box 153, the communication module 38 stores an acknowledgement response in the electronic response message.

At box 150, the communication module 38 communicates the electronic response message to the server machine 12. The error code indicates that the receiver network address 69 is an invalid network address. Other embodiments may utilize other error codes to discourage the sender from communicating additional e-mail 60.

At box 152, the mailing module 26, at the server machine 12, receives the electronic response message responsive to a communication of the receiver network address 69. The electronic response message includes an error code indicating that the previously communicated receiver network address 69 is an invalid network address. The mailing module 26 may store, display, or print error information (e.g., the error code, the sender network address 67, and the receiver network address 69, etc.) at the server machine 12 to notify an administrator that the mailing list 74 includes a receiver network address 69 that is invalid. In other embodiments the mailing module 26 may forward the error information to the user 15 (e.g., the author). Yet other embodiments may include other mechanisms (e.g., notification) that may be utilized to publish, communicate or disseminate the error information and thereby discourage the sender from sending additional e-mails 60 to the user 18 at the receiver network address 69.

At box 157, the mailing module 26 communicates the body 64 of the e-mail 60 to the server machine 14.

At box 159 the communicating module 38, at the server machine 14, receives the body 64 of the e-mail 60 and processing ends.

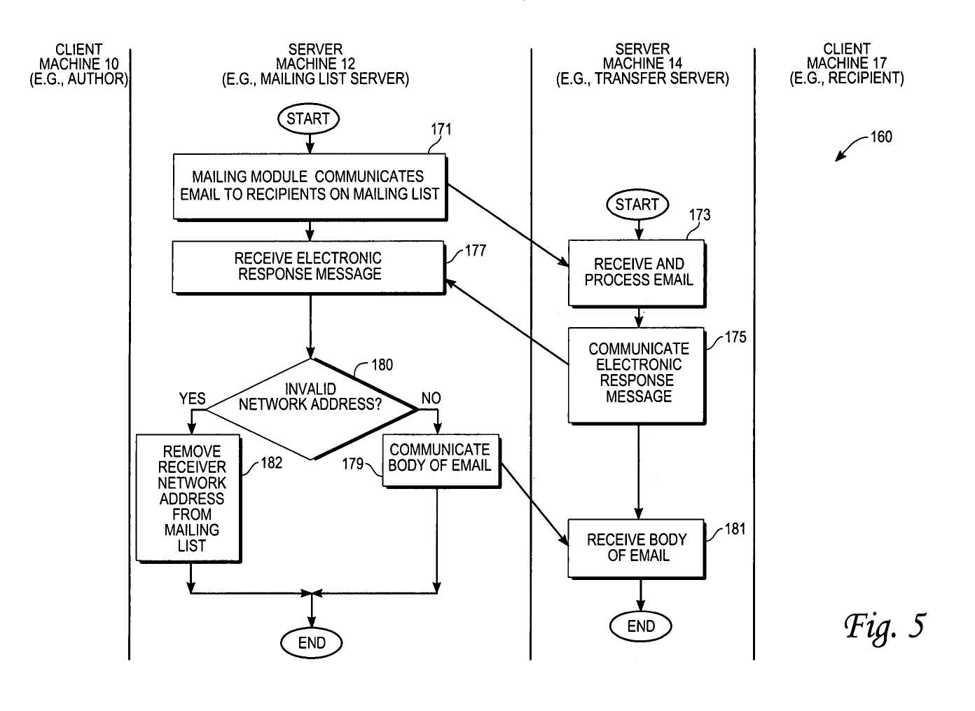

FIG. 5 is a flowchart illustrating a method 160, according to an exemplary embodiment, to automatically remove a user from a mailing list.

At box 171, the server machine 12 receives an e-mail 60 from a user 15 and the mailing module 26 communicates the e-mail 60 to recipients on a mailing list as previously described in box 90 on FIG. 4.

At box 173, the server machine 14 receives and processes a header 62 of an e-mail 60 as previously described in boxes 92, 146, 148, 149, and 153 on FIG. 4.

At box 175, the server machine 14 communicates an electronic response message to the server machine 12 as previously described in box 150 on FIG. 4.

At box 177, the mailing module 26, on the server machine 12, receives an electronic response message as previously described in box 152 on FIG. 4.

At decision box 180, the mailing module 26, on the server machine 12, determines if the error code in the electronic response message indicates an invalid network address. If the mailing module 26 determines there is an invalid network address error code, a branch is made to box 182. Otherwise, a branch is made to box 179.

At box 182, the removing module 28 automatically removes the receiver network address 69 from the mailing list 74 that is currently being processed.

At box 179, the server machine 12 communicates the body 64 of the e-mail 60 to the server machine 14 as described in box 157 on FIG. 4.

At box 181, the server machine 14 receives and processes the body 64 of the e-mail 60 as previously described in box 159 on FIG. 4.

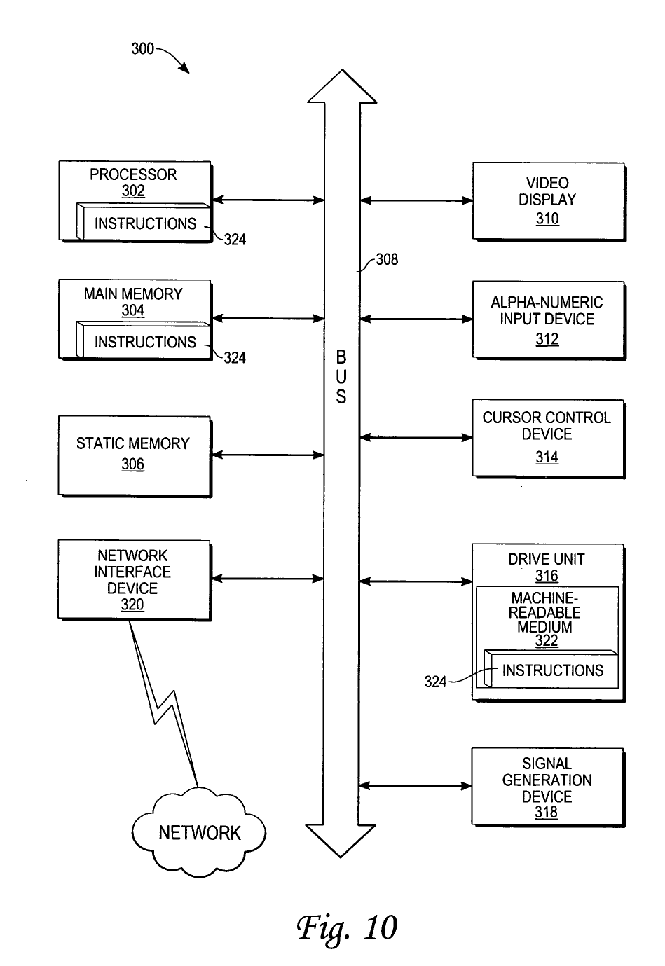

FIG. 10 shows a diagrammatic representation of a machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 392 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to discourage a sender from sending an electronic message to a user has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system to update a filter to discourage a sender that communicates an electronic message to a user, the system including:
a filtering module to receive a first electronic message from a sender, the electronic message including a network address of the sender, the filtering module to determine whether to discourage the sender from communicating a second electronic message to the user; and
if so determined, an updating module to update the filter, the update to the filter including a registration of the network address of the sender in the filter that is utilized to communicate an electronic response message to the sender, the electronic response message to discourage the sender to communicate the second electronic message to the user.

2. The system of claim 1, wherein the electronic response message includes an error code.

3. The system of claim 2, wherein the error code indicates that the network address of the user is an invalid network address.

4. The system of claim 3, wherein the filtering module is to receive input that is manually entered by a user to identify the first electronic message as spam.

5. The system of claim 4, wherein the filter is personal to the user.

6. The system of claim 1, wherein the network address of the sender includes an e-mail address.

7. The system of claim 1, wherein the sender includes at least one of a mailing list application that processes a mailing list and a second user.

8. A method to update a filter to discourage a sender from communicating an electronic message to a user, the method including:
receiving a first electronic message from a sender, the electronic message including a network address of the sender;
determining whether to discourage the sender from communicating a second electronic message to the user; and
if so determined, updating the filter by registering the network address of the sender in the filter that is utilized in communicating an electronic response message to the sender, the electronic response message to discourage the sender from communicating the second electronic message to the user.

9. The method of claim 8, wherein the electronic response message includes an error code.

10. The method of claim 9, wherein the error code indicates that the network address of the user is an invalid network address.

11. The method of claim 8, wherein the determining includes receiving input that identifies the first electronic message as spam, the input being manually entered by a user.

12. The method of claim 11, wherein the filter is personal to the user.

13. The method of claim 8, wherein the network address of the sender includes an e-mail address.

14. The method of claim 8, wherein the sender includes at least one of a mailing list application that processes a mailing list and a second user.

15. A method to use a filter to discourage a sender from communicating electronic messages to a user, the method including:
receiving an electronic message from a sender, the electronic message including a network address of the sender;
identifying that the sender is to be discouraged from communicating a second electronic message to the user using the filter, the filter being updated by registering the network address of the sender to the filter; and
communicating an electronic response message to the sender, the electronic response message to discourage the sender from communicating the second electronic message to the user.

16. The method of claim 15, wherein the electronic response message includes an error code that identifies the network address of the user as an invalid network address.

17. The method of claim 15, wherein the identifying includes determining that the filter includes the network address of the sender.

18. The method of claim 15, wherein the electronic response message is an electronic error message.

19. The method of claim 15, wherein the identifying includes requesting the filter.

20. The method of claim 19, wherein the identifying is performed responsive to receiving the filter.

21. The method of claim 15, wherein the electronic message comprises any one of a group including an e-mail, an RFC 822 electronic message and an X.400 electronic message.

22. A system to use a filter to discourage a sender to communicate electronic messages to a user, the system including:
a communicating module to receive an electronic message from a sender, the electronic message including a network address of the sender;
an identifying module to identify that the sender is to be discouraged from communicating a second electronic message to the user, the identifying module to use the filter and the filter being updated by registration of the network address of the sender to the filter;
where the communicating module is to communicate an electronic response message to the sender, the electronic response message to discourage the sender from communicating the second electronic message to the user.

23. The system of claim 22, wherein the electronic response message includes an error code that indicates the network address of the user is an invalid network address.

24. The system of claim 22, wherein the identifying module is to determine that the filter includes the network address of the sender.

25. The system of claim 22, wherein the electronic response message is an electronic error message.

26. The system of claim 22, wherein the identifying module is to request the filter.

27. The system of claim 26, wherein the identifying module is to identify responsive to receiving the filter.

28. The system of claim 22, wherein the electronic message comprises any one of a group including an e-mail, an RFC 822 electronic message and an X.400 electronic message.

29. A method to automatically remove a user from a mailing list, the method including:
at a server machine, electronically communicating a first electronic message to a plurality of users respectively identified in a mailing list;
at the server machine, receiving a second electronic message that is associated with a user that is included in the plurality of users, the second electronic message including an error code; and
at the server machine, automatically removing the user from the mailing list based on the error code.

30. The method of claim 29, wherein the error code indicates an invalid network address.

31. The method of claim 29, wherein the automatically removing includes automatically removing the network address of the user from the mailing list.

32. A system to automatically remove a user from a mailing list, the system including:
at a server machine, a mailing module to electronically communicate a first electronic message to a plurality of users respectively identified in a mailing list, the mailing module to receive a second electronic message that is associated with a user that is included in the plurality of users, the second electronic message including an error code;
at the server machine, a removing module to automatically remove the user from the mailing list based on the error code.

33. The system of claim 32, wherein the error code indicates an invalid network address.

34. The system of claim 32, wherein the removing module to automatically remove the user is automatically to remove the network address of the user from the mailing list.

35. A machine readable medium storing a set of instructions that, when executed by a machine, cause the machine to:
receive a first electronic message from a sender, the electronic message including a network address of the sender;
determine whether to discourage the sender to communicate a second electronic message to the user; and
if so determined, update the filter, the update to register the network address of the sender in the filter that is utilized to communicate an electronic response message to the sender, the electronic response message to discourage the sender from sending the second electronic message to the user.

36. A machine readable medium storing a set of instructions that, when executed by a machine, cause the machine to:
receive an electronic message from a sender, the electronic message to include a network address of the sender;
identify that the sender is to be discouraged to communicate a second electronic message to the user with the use of a filter, the filter updated by registration of the network address of the sender to the filter; and
communicate an electronic response message to the sender, the electronic response message to discourage the sender to communicate the second electronic message to the user.

37. A machine readable medium storing a set of instructions that, when executed by a machine, cause the machine to:
electronically communicate a first electronic message to a plurality of users respectively identified in a mailing list;
receive a second electronic message that is associated with a user that is included in the plurality of users, the second electronic message to include an error code; and
automatically remove the user from the mailing list based on the error code.

38. A system to automatically remove a user from a mailing list, the system including:
at a server machine, a first means for electronically communicating a first electronic message to a plurality of users respectively identified in a mailing list, the first means for receiving a second electronic message that is associated with a user that is included in the plurality of users, the second electronic message including an error code;
at the server machine, a second means for automatically removing the user from the mailing list based on the error code.
